(19) United States
(12) Patent Application Publication
(10) Pub. No.: US 2020/0300082 A1
(43) Pub. Date: Sep. 24, 2020

(54) Calculation method for dynamic fluid loss of acid-etched fracture considering wormhole propagation

(71) Applicants: SOUTHWEST PETROLEUM UNIVERSITY, Chengdu City (CN); PETROCHINA COMPANY LIMITED, Beijing (CN)

(72) Inventors: Pingli Liu, CHENGDU CITY (CN); Xiang Chen, CHENGDU CITY (CN); Heng Xue, CHENGDU CITY (CN); Honglan Zou, CHENGDU CITY (CN); Liqiang Zhao, CHENGDU CITY (CN); Nianyin Li, CHENGDU CITY (CN); Daocheng Wang, CHENGDU CITY (CN); Zhifeng Luo, CHENGDU CITY (CN); Juan Du, CHENGDU CITY (CN); Chong Liang, CHENGDU CITY (CN); Mingyue Cui, CHENGDU CITY (CN); Fei Liu, CHENGDU CITY (CN); Changlin Zhou, CHENGDU CITY (CN); Rong Zeng, CHENGDU CITY (CN)

(73) Assignees: SOUTHWEST PETROLEUM UNIVERSITY, CHENGDU CITY (CN); PETROCHINA COMPANY LIMITED, Beijing (CN)

(21) Appl. No.: 16/899,546

(22) Filed: Jun. 11, 2020

(30) Foreign Application Priority Data
Sep. 9, 2019 (CN) 2019108578385

(51) Int. Cl. E21B 47/10; E21B 43/27; G06F 30/28; G06F 17/11

(52) U.S. Cl. CPC E21B 47/10; E21B 43/27; G06F 2113/08; G06F 17/11; G06F 30/28

(57) ABSTRACT

The invention discloses a calculation method for dynamic fluid loss of acid-etched fracture considering wormhole propagation, which is applied to pad acid fracturing process, comprising the following steps: Step 1: dividing the construction time T of injecting acid fluid into artificial fracture into m time nodes at equal intervals, then the time step Δₜ=T/m and tₙ=nΔt, where, n=0, 1, 2, 3, . . . , m, and to is the initial time; Step 2: calculating the fluid loss velocity vₗ(0) in the fracture at t₀; Step 3: calculating the flowing pressure distribution P(n) in the fracture at tₙ; Step 4: calculating the width wₐ(n) of acid-etched fracture at tₙ; Step 5: calculating the wormhole propagation and the fluid loss velocity vₗ(n) at tₙ; Step 6: substituting the fluid loss velocity vₗ(n) into Step 3, and repeating Step 3 to Step 6 in turn until the end of acid fluid injection.

### BACKGROUND OF THE INVENTION

### Field of the Invention

The invention relates to the technical field of oil and gas development, in particular to a calculation method for dynamic fluid loss of acid-etched fracture considering wormhole propagation in the process of pad acid fracturing.

### Description of Related Art

Carbonate reservoir is an important part of global oil and gas resources. More than half of the world's oil and gas reservoirs are carbonate reservoirs. The carbonate reservoir in China is also considerable, equivalent to 58.3 billion tons of crude oil. The acid fracturing, as the key technology of carbonate reservoir stimulation, has been widely applied to many oilfields at home and abroad.

The acid fracturing technologies used in carbonate reservoir stimulation include common acid fracturing and pad acid fracturing. The common acid fracturing is to directly use acid fluid to fracture the formation to produce fractures and etch the fracture wall. The pad acid fracturing is the technology to fracture the formation by inert fracturing fluid system with high viscosity to make artificial fractures, and then inject acid fluid into the fractures.

For reactive acid fluid system, the fluid will continuously etch the rock surface, so it cannot effectively form filter cake; at the same time, the acid fluid from the fracture to the bedrock will produce wormholes, and the wormholes will bring about more fluid loss, which is a self-amplification process, and may lead to excessive acid fluid loss. Therefore, the classical formula for calculating the fluid loss coefficient of inert fracturing fluid system is no longer suitable for calculating the fluid loss coefficient of acid fluid with reactive activity.

### SUMMARY OF THE INVENTION

The purpose of the invention is to provide a calculation method for the dynamic fluid loss of acid-etched fracture considering wormhole propagation in the process of pad acid fracturing, in view of the state of the art that the formula for calculating the fluid loss coefficient of inert fracturing fluid system is no longer suitable for calculating the fluid loss coefficient of acid fluid with reactive activity.

The calculation method for the dynamic fluid loss of acid-etched fracture considering wormhole propagation in the process of pad acid fracturing, disclosed in the present invention, comprises the following steps:

Step 1: Dividing the construction time T of injecting acid fluid into artificial fracture into m time nodes at equal intervals, then the time step

$$Δ t = \frac{T}{m}$$

and tₙ=nΔt, where, n=0, 1, 2, 3, . . . , m, and to is the initial time, i.e., the time to start to inject the acid fluid;

Step 2: Calculating the fluid loss velocity vₗ(0) in the fracture at to; the acid fluid does not react with the rock at to, and the fluid loss velocity vₗ(0) is determined by the fluid loss velocity of the hydraulic fracture propagating to the last time node; the fluid loss velocity vₗ(0) is calculated by Formula (1) in Step 2:

$${v}_{l} ( 0 ) = \frac{2 C ( x , b )}{\sqrt{b - τ}} ; \qquad ( 1 )$$

wherein, C (x, t) is the fluid loss coefficient at x place in the fracture at t, in m/min^{0.5};

b is the construction time of artificial fracture, in min;

τ is the time when the fluid reaches fracture x, in min.

Step 3: Calculating the flowing pressure distribution P(n) in the fracture at tₙ; the calculation process is as follows:

The average velocity vₓ and v_{y} of acid fluid flowing any point (x, y) in the fracture:

$$\begin{matrix}{v}_{x} = - \frac{{w}^{2}}{12 {μ}_{a}} \frac{\partial P}{\partial x} ; & ( 2 ) \\ {v}_{y} = - \frac{{w}^{2}}{12 {μ}_{a}} \frac{\partial P}{\partial y} . & ( 3 )\end{matrix}$$

The amount of change in the acid fluid mass in the unit volume within a unit time is equal to the total inflow of acid fluid minus the total outflow, and then the mass conservation equation of the acid fluid in the fracture is worked out:

$$- \frac{\partial ( {v}_{x} w )}{\partial x} - \frac{\partial ( {v}_{y} w )}{\partial y} - 2 {v}_{l} = \frac{\partial w}{\partial t} ; \qquad ( 4 )$$

wherein, μₐ is the viscosity of acid fluid, in mPa·s;

P is pressure, in MPa;

vₗ is the fluid loss velocity, in m/min;

w is the fracture width, in m; w is taken as the width w_{f} of artificial hydraulic fracture at t₀, and taken as the width wₐ of acid etched fracture at tₙ (notes: where the subscript n is greater than 0).

If the time step Δt is small enough, it can be considered that the fluid loss velocity of acid fluid does not change within Δt, that is, the fluid loss velocity at tₙ₋₁ can be used within the period from t to tₙ. Therefore, in the calculation of the flowing pressure distribution P(n) at to, adopt the fluid loss velocity vₗ(n−1) at tₙ₋₁, substitute the fluid loss velocity vₗ(n−1), Formula (2) and Formula (3) into Formula (4), and work out the flowing pressure distribution P(n) in the fracture.

Step 4: Calculating the width wₐ(n) of acid etched fracture at tₙ in acid fracturing; the specific process is as follows:

The acid fluid concentration at each point in the fracture before acid injection is set as 0. In the process of acid fracturing, the injection rate of acid fluid is constant, there is no acid fluid flowing at the top and bottom of the fracture (i.e., at y=−H and y=H), the pressure at the fracture outlet (i.e., at x=L) is the formation pressure, and the acid fluid concentration at the fracture inlet is C_{f}⁰.

The P(n) obtained in Step 3 is taken as the internal boundary condition, and the width wₐ(n) of acid-etched fracture at to is calculated by combining the initial condition formula (5) and the boundary condition formula (6).

Initial condition:

$$\{ \begin{matrix}P ( x , y ) = 0 , ∀ x , y , t = 0 \\ {C}_{f} ( x , y ) = 0 , ∀ x , y , t = 0 \\ {w}_{a} ( x , y ) = {w}_{f} ( x , y , end ) , ∀ x , y , t = 0\end{matrix} . \qquad ( 5 )$$

Boundary condition:

$$\{ \begin{matrix}{\int }_{- H}^{H} \frac{{w}_{a}^{3}}{12 {μ}_{a}} \frac{\partial P}{\partial x} {\vert}_{x = 0} dy = {q}_{inj} , t > 0 \\ P ( l , y ) = {P}_{e} , ∀ y , t > 0 \\ \frac{\partial P}{Φ} {\vert}_{y = - H} = 0 , ∀ x , t > 0 \\ \frac{\partial P}{Φ} {\vert}_{y = H} = 0 , ∀ x , t > 0 \\ {C}_{f} ( 0 , y ) = {C}_{f}^{0} , ∀ y , t > 0\end{matrix} . \qquad ( 6 )$$

Equation for reaction equilibrium in acid-etched fracture:

$$[ \begin{matrix}\frac{\partial ( {C}_{f} {v}_{x} {w}_{a} )}{\partial x} + \frac{\partial ( {C}_{f} {v}_{y} {w}_{a} )}{\partial y} + \\ 2 {C}_{f} {v}_{l} + 2 {k}_{g} ( {C}_{f} - {C}_{w} )\end{matrix} ] = - \frac{\partial ( {C}_{f} {w}_{a} )}{\partial t} . \qquad ( 7 )$$

Equation for local reaction on fracture wall:

k_{g}(C_{f}−C_{w})=R(C_{w}) (8).

Equation for width change of acid-etched fracture:

$${\sum }_{i = 1}^{2} \frac{{β}_{i}}{{ρ}_{i} ( 1 - φ )} ( 2 η {v}_{l} {C}_{f} + 2 {R}_{i} ( {C}_{w} ) ) = \frac{\partial {w}_{a}}{\partial t} . \qquad ( 9 )$$

Where: C_{f} is the acid fluid concentration in the center of fracture, in kmol/m³;

qᵢₙⱼ is the injection rate of acid fluid, in m³/min;

Pₑ is the pressure at the fracture outlet, in MPa;

C_{f}⁰ is the acid fluid concentration at the fracture inlet, in kmol/m³;

k_{g} is the mass transfer coefficient, in m/s;

C_{w} is the acid fluid concentration at fracture wall, in kmol/m³;

R(C_{w}) is the corrosion rate of irreversible reaction in single step, in m·kmol/(s·m³);

βᵢ is the solubility between acid fluid and limestone or dolomite, in kg/kmol;

ρᵢ is the density of limestone or dolomite, in kg/m³;

i is the subscript, indicating different rock types;

ϕ is the porosity, dimensionless;

η is the percentage of lost acid fluid that reacts with fracture wall rock; in most cases n≈0.

Step 5: Calculating the wormhole propagation and the fluid loss velocity vₗ(n) at tₙ; the calculation process is as follows:

Formulas (11) to (13) are used to simulate the dynamic propagation of the wormhole, and then Formula (10) is substituted to calculate v. The fluid loss velocity vₗ(n) is equal to the fluid loss velocity v(x, y) on the fracture surface.

Equation for distribution of acid fluid concentration:

$$\frac{\partial ( φ {C}_{f} )}{\partial t} + \frac{\partial }{\partial x} ( {v}_{x} {C}_{f} ) + \frac{\partial }{\partial y} ( {v}_{y} {C}_{f} ) = \frac{\partial }{\partial x} ( φ {D}_{e x} \frac{\partial {C}_{f}}{\partial x} ) + \frac{\partial }{\partial y} ( φ {D}_{e y} \frac{\partial {C}_{f}}{\partial y} ) - {\sum }_{i} {R}_{i} ( {C}_{w} ) {a}_{vi} . \qquad ( 10 )$$

Equation for reaction between acid fluid and rock:

$${R}_{i} ( {C}_{w} ) = \frac{{k}_{ci} {k}_{si} {γ}_{{H}^{+} , s}}{{k}_{ci} + {k}_{si} {γ}_{{H}^{+} , s}} {C}_{f} . \qquad ( 11 )$$

Equation for volume change of different minerals:

$$\frac{\partial {V}_{i}}{\partial t} = - \frac{{M}_{a c i d} {R}_{i} ( {C}_{w} ) {a}_{vi} {α}_{i}}{{ρ}_{i}} . \qquad ( 12 )$$

Equation for porosity change:

$$\frac{\partial φ}{\partial t} = - {\sum }_{i} \frac{\partial {V}_{i}}{\partial t} . \qquad ( 13 )$$

Where: Dₑₓ is the effective propagation coefficient tensor in x direction, in m²/s;

D_{ey} is the effective propagation coefficient tensor in y direction, in m²/s;

Rᵢ(C_{w}) is the dissolution reaction rate between acid and different minerals, in kmol/s m²;

aᵥᵢ is the surface area per unit volume of different minerals, in m²/m³;

kₛᵢ is the reaction rate constant, in m/s;

k_{ci} is mass transfer coefficient, in m/s;

γ_{H+,s} is the activity coefficient of the acid fluid, dimensionless;

Vᵢ is the volume fraction of the i^{th} mineral, dimensionless;

M_{acid} is the molar mass of the acid fluid, in kg/kmol;

αᵢ is the solubility of the acid fluid, in kg/kg;

ρᵢ is the density of the i^{th} mineral, in kg/m³.

Step 6: Substituting the calculated fluid loss velocity vₗ(n) into Step 3 to calculate the pressure P(n+1) in the fracture at tₙ₊₁, and then repeating Step 3 to Step 6 in turn to work out wₐ(n+1) and vₗ(n+1), and ending the repeated calculation when the injected volume of the acid fluid is equal to the set total volume.

In the above calculation method, the same symbols involved in all formulas have the same meaning. After being marked once, they are all common for all formulas.

FIG. 1 shows the flow chart of calculation of dynamic fluid loss of acid-etched fracture considering wormhole propagation of the present invention.

The inventor found that the existing patent CN201810704079.4 discloses a calculation method for dynamic comprehensive fluid loss coefficient of acid fracturing in fractured reservoir. Compared with the calculation methods in the existing patent and the present invention, there are the following differences: (1) The present invention aims at the artificial fractures produced before acid fluid injection and the initial pressure in the fracture is no longer the original formation pressure, but the published patent aims at the natural fracture and the initial pressure in the fracture is the original formation pressure. (2) In the present invention, the acid fluid loss considering the wormhole effect changes dynamically as the injection process continues, while in the published patent, only Steps (3) to (6) are repeated in the calculation process, and the acid fluid loss coefficient considering the wormhole effect is a constant value. (3) The present invention aims at the pad fracturing process, specifically forming artificial fractures first and then injecting acid fluid, while the published patent relates to natural fractures, and no artificial fractures or filter cake is produced, so the calculation method of fluid loss coefficient at the initial time is different.

The present invention has the following beneficial effects:

The calculation method of the present invention takes into account the influence of the dynamic propagation of the wormholes and the continuous change of the width of acid-etched fracture on the fluid loss velocity, so as to more accurately calculate the fluid loss during acid fracturing. It is of great significance for rational design of acid fluid volume, calculation of effective acting distance of acid fluid, and prediction of the stimulation effect of acid fracturing.

Other advantages, objectives and characteristics of the present invention will be partly embodied by the following description, and partly understood by those skilled in the art through research and practice of the present invention.

### BRIEF DESCRIPTION OF THE DRAWINGS

Aspects of the present invention are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flow chart of calculation of dynamic fluid loss of acid-etched fracture considering wormhole propagation.

FIG. 2 illustrates the shape and geometric dimensions of the artificial fracture before acid fluid injection.

FIG. 3 is a width profile of etched fracture.

FIG. 4 is a comparison curve between the fracture width after etching and the artificial fracture width before etching.

FIG. 5 is a profile of distribution of acid fluid concentration.

FIG. 6 is a curve showing the distribution of acid fluid concentration along the fracture length.

FIG. 7 is a curve showing the fluid loss velocity along the fracture length.

### DESCRIPTION OF THE PREFERRED EMBODIMENTS

In the following detailed description of the preferred embodiments of the present invention, reference is made to the accompanying drawings. It is to be understood that the preferred embodiments described herein are only used to illustrate and interpret the present invention and are not intended to limit the present invention.

### Example 1

The pad acid fracturing technology was used in a carbonate reservoir, and the basic parameters measured are shown in Table 1.

TABLE 1
List of Basic Parameters for Calculation in Example 1

| Object | Parameters | Unit | Values |
|---|---|---|---|
| Target layer | Stress | MPa | 95 |
| | Fracture toughness | MPa · m^{0.5} | 0.5 |
| | Elastic modulus | MPa | 71660 |
| | Poisson's ratio | — | 0.23 |
| | Permeability | mD | 0.662 |
| | Temperature | ° C. | 157 |
| Caprock/ | Stress | MPa | 105 |
| bottom layer | Elastic modulus | MPa | 50264 |
| | Poisson's ratio | — | 0.25 |
| Acid fluid | Injection rate | m³/min | 4.5~5 |
| | Volume | m³ | 220 |
| | Concentration | wt % | 20 |
| | Type | / | Gelled acid |
| | Reaction order | — | 1.2289 |
| | Solubility | kg/kg | 1.37 |
| | Activation energy | J/mol | 5277 |
| | Mass transfer | m²/s | 3.6 × 10⁻¹⁰ |
| | coefficient | | |
| | Frequency factor | (mol/L)^{1-m}/s | 3.6985 × 10⁻⁶ |

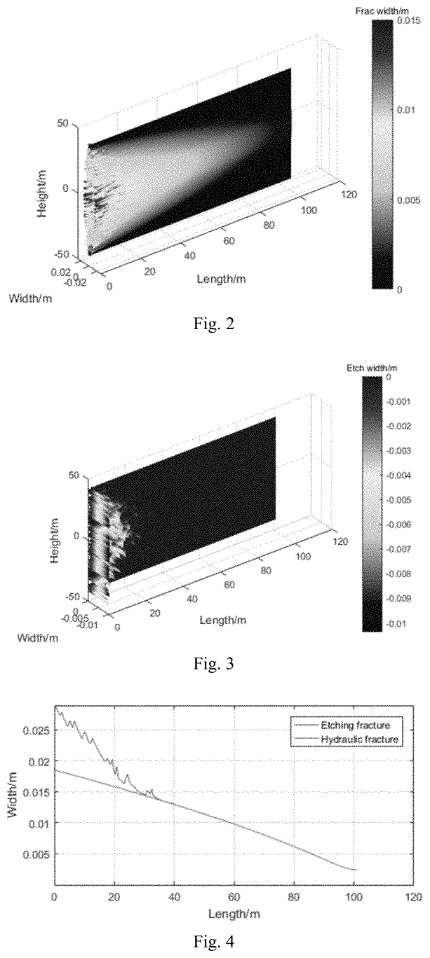

Based on the data in Table 1, the artificial fractures produced by the fracturing with non-reactive inert pad fluid are shown in FIG. 2. The present invention is performed based on the artificial fracture. The fluid loss velocity vₗ(0) of the fracture at to in Step 2 in the present invention is calculated as follows:

The fracturing time (construction time b) of the pad fluid is 48 min. At the beginning of acid fluid injection, the time step is short and the fluid is mainly near the fracture, so the fluid loss coefficient C(x, b) is considered as the fluid loss coefficient at the fracture, i.e., 0.76×10⁻³ m/min^{0.5}; τ is far less than b, and can be ignored and taken as 0. The fluid loss velocity is calculated by Formula (1) to be 0.22×10⁻³ m/min.

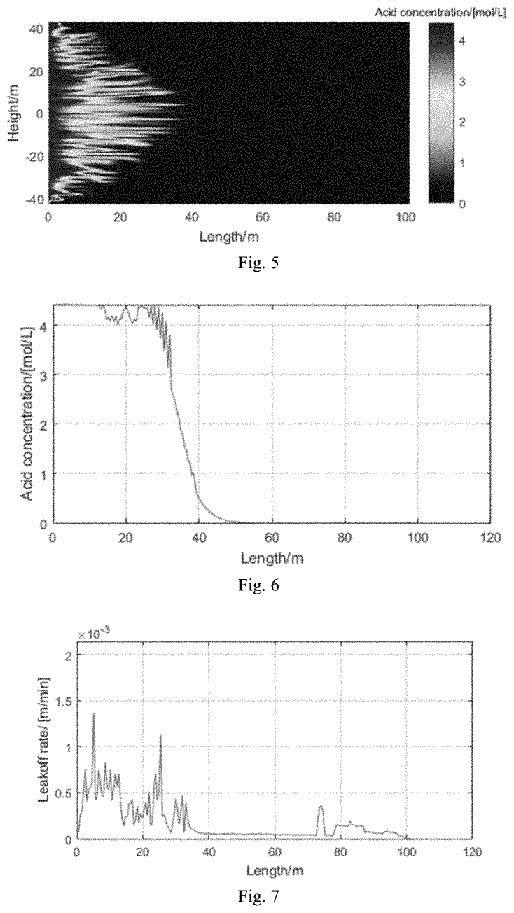

The results calculated from Step 3 to Step 6 are reflected in form of cloud chart or irregular curve, and cannot be represented by a specific value or algebraic expression, so that Step 3 to Step 6 are directly repeated until the end of acid fluid injection. The final calculation result is shown in FIGS. 3 to 7.

The calculation method for the dynamic fluid loss of acid-etched fracture considering wormhole propagation in the process of pad acid fracturing, disclosed in the present invention, comprises the following steps:

Step 1: Dividing the construction time T of injecting acid fluid into artificial fracture into m time nodes at equal intervals, then the time step

$$Δ t = \frac{T}{m}$$

and tₙ=nΔt, where, n=0, 1, 2, 3, . . . , m, and to is the initial time, i.e., the time to start to inject the acid fluid;

Step 2: Calculating the fluid loss velocity vₗ(0) in the fracture at to; the acid fluid does not react with the rock at to, and the fluid loss velocity vₗ(0) is determined by the fluid loss velocity of the hydraulic fracture propagating to the last time node; the fluid loss velocity vₗ(0) is calculated by Formula (1) in Step 2:

$${v}_{l} ( 0 ) = \frac{2 C ( x , b )}{\sqrt{b - τ}} ; \qquad ( 1 )$$

wherein, C (x, t) is the fluid loss coefficient at x place in the fracture at t, in m/min^{0.5};

b is the construction time of artificial fracture, in min;

τ is the time when the fluid reaches fracture x, in min.

Step 3: Calculating the flowing pressure distribution P(n) in the fracture at to; the calculation process is as follows:

The average velocity vₓ and v_{y} of acid fluid flowing any point (x, y) in the fracture:

$$\begin{matrix}{v}_{x} = - \frac{{w}^{2}}{12 {μ}_{a}} \frac{\partial P}{\partial x} ; & ( 2 ) \\ {v}_{y} = - \frac{{w}^{2}}{12 {μ}_{a}} \frac{\partial P}{\partial y} . & ( 3 )\end{matrix}$$

The amount of change in the acid fluid mass in the unit volume within a unit time is equal to the total inflow of acid fluid minus the total outflow, and then the mass conservation equation of the acid fluid in the fracture is worked out:

$$- \frac{\partial ( {v}_{x} w )}{\partial x} - \frac{\partial ( {v}_{y} w )}{\partial y} - 2 {v}_{l} = \frac{\partial w}{\partial t} ; \qquad ( 4 )$$

wherein, μₐ is the viscosity of acid fluid, in mPa·s;

P is pressure, in MPa;

vₗ is the fluid loss velocity, in m/min;

w is the fracture width, in m; w is taken as the width w_{f} of artificial hydraulic fracture at t₀, and taken as the width wₐ of acid etched fracture at to (notes: where the subscript n is greater than 0).

If the time step Δt is small enough, it can be considered that the fluid loss velocity of acid fluid does not change within Δt, that is, the fluid loss velocity at tₙ₋₁ can be used within the period from tₙ₋₁ to tₙ. Therefore, in the calculation of the flowing pressure distribution P(n) at to, adopt the fluid loss velocity vₗ(n−1) at tₙ₋₁, substitute the fluid loss velocity vₗ(n−1), Formula (2) and Formula (3) into Formula (4), and work out the flowing pressure distribution P(n) in the fracture.

Step 4: Calculating the width wₐ(n) of acid etched fracture at Tₙ in acid fracturing; the specific process is as follows:

The acid fluid concentration at each point in the fracture before acid injection is set as 0. In the process of acid fracturing, the injection rate of acid fluid is constant, there is no acid fluid flowing at the top and bottom of the fracture (i.e., at y=−H and y=H), the pressure at the fracture outlet (i.e., at x=L) is the formation pressure, and the acid fluid concentration at the fracture inlet is C_{f}⁰.

The P(n) obtained in Step 3 is taken as the internal boundary condition, and the width wₐ(n) of acid-etched fracture at tₙ is calculated by combining the initial condition formula (5) and the boundary condition formula (6).

Initial condition:

$$\{ \begin{matrix}P ( x , y ) = 0 , ∀ x , y , t = 0 \\ {C}_{f} ( x , y ) = 0 , ∀ x , y , t = 0 \\ {w}_{a} ( x , y ) = {w}_{f} ( x , y , end ) , ∀ x , y , t = 0\end{matrix} . \qquad ( 5 )$$

Boundary condition:

$$\{ \begin{matrix}{\int }_{- H}^{H} \frac{{w}_{a}^{3}}{12 {μ}_{a}} \frac{\partial P}{\partial x} {\vert}_{x = 0} dy = {q}_{inj} , t > 0 \\ P ( l , y ) = {P}_{e} , ∀ y , t > 0 \\ \frac{\partial P}{\partial y} {\vert}_{y = - H} = 0 , ∀ x , t > 0 \\ \frac{\partial P}{\partial y} {\vert}_{y = H} = 0 , ∀ x , t > 0 \\ {C}_{f} ( 0 , y ) = {C}_{f}^{0} , ∀ y , t > 0\end{matrix} . \qquad ( 6 )$$

Equation for reaction equilibrium in acid-etched fracture:

$$[ \begin{matrix}\frac{\partial ( {C}_{f} {v}_{x} {w}_{a} )}{\partial x} + \frac{\partial ( {C}_{f} {v}_{y} {w}_{a} )}{\partial y} + \\ 2 {C}_{f} {v}_{l} + 2 {k}_{g} ( {C}_{f} - {C}_{w} )\end{matrix} ] = - \frac{\partial ( {C}_{f} {w}_{a} )}{\partial t} . \qquad ( 7 )$$

Equation for local reaction on fracture wall:

k_{g}(C_{f}−C_{w})=R(C_{w}) (8).

Equation for width change of acid-etched fracture:

$${\sum }_{i = 1}^{2} \frac{{β}_{i}}{{ρ}_{i} ( 1 - φ )} ( 2 η {v}_{l} {C}_{f} + 2 {R}_{i} ( {C}_{w} ) ) = \frac{\partial {w}_{a}}{\partial t} . \qquad ( 9 )$$

Where: C_{f} is the acid fluid concentration in the center of fracture, in kmol/m³;

qᵢₙⱼ is the injection rate of acid fluid, in m³/min;

Pₑ is the pressure at the fracture outlet, in MPa;

C_{f}⁰ is the acid fluid concentration at the fracture inlet, in kmol/m³;

k_{g} is the mass transfer coefficient, in m/s;

C_{w} is the acid fluid concentration at fracture wall, in kmol/m³;

R(C_{w}) is the corrosion rate of irreversible reaction in single step, in m·kmol/(s·m³);

βᵢ is the solubility between acid fluid and limestone or dolomite, in kg/kmol;

ρᵢ is the density of limestone or dolomite, in kg/m³;

i is the subscript, indicating different rock types;

ϕ is the porosity, dimensionless;

η is the percentage of lost acid fluid that reacts with fracture wall rock; in most cases η≈0.

Step 5: Calculating the wormhole propagation and the fluid loss velocity vₗ(n) at tₙ; the calculation process is as follows:

Formulas (11) to (13) are used to simulate the dynamic propagation of the wormhole, and then Formula (10) is substituted to calculate v. The fluid loss velocity vₗ(n) is equal to the fluid loss velocity v(x, y) on the fracture surface.

Equation for distribution of acid fluid concentration:

$$\frac{\partial ( φ {C}_{f} )}{\partial t} + \frac{\partial }{\partial x} ( {v}_{x} {C}_{f} ) + \frac{\partial }{\partial y} ( {v}_{y} {C}_{f} ) = \frac{\partial }{\partial x} ( φ {D}_{e x} \frac{\partial {C}_{f}}{\partial x} ) + \frac{\partial }{\partial y} ( φ {D}_{e y} \frac{\partial {C}_{f}}{\partial y} ) - {\sum }_{i} {R}_{i} ( {C}_{w} ) {a}_{vi} . \qquad ( 10 )$$

Equation for reaction between acid fluid and rock:

$${R}_{i} ( {C}_{w} ) = \frac{{k}_{ci} {k}_{si} {γ}_{{H}^{+} , s}}{{k}_{ci} + {k}_{si} {γ}_{{H}^{+} , s}} {C}_{f} . \qquad ( 11 )$$

Equation for volume change of different minerals:

$$\frac{\partial {V}_{i}}{\partial t} = - \frac{{M}_{a c i d} {R}_{i} ( {C}_{w} ) {a}_{vi} {α}_{i}}{{ρ}_{i}} . \qquad ( 12 )$$

Equation for porosity change:

$$\frac{\partial φ}{\partial t} = - {\sum }_{i} \frac{\partial {V}_{i}}{\partial t} . \qquad ( 13 )$$

Where: Dₑₓ is the effective propagation coefficient tensor in x direction, in m²/s;

D_{ey} is the effective propagation coefficient tensor in y direction, in m²/s;

Rᵢ(C_{w}) is the dissolution reaction rate between acid and different minerals, in kmol/s m²;

aᵥᵢ is the surface area per unit volume of different minerals, in m²/m³;

kₛᵢ is the reaction rate constant, in m/s;

k_{ci} is mass transfer coefficient, in m/s;

γ_{H+,s} is the activity coefficient of the acid fluid, dimensionless;

Vᵢ is the volume fraction of the i^{th} mineral, dimensionless;

M_{acid} is the molar mass of the acid fluid, in kg/kmol;

αᵢ is the solubility of the acid fluid, in kg/kg;

ρᵢ is the density of the i^{th} mineral, in kg/m³.

Step 6: Substituting the calculated fluid loss velocity vₗ(n) into Step 3 to calculate the pressure P(n+1) in the fracture at tₙ₊₁, and then repeating Step 3 to Step 6 in turn to work out wₐ(n+1) and vₗ(n+1), and ending the repeated calculation when the injected volume of the acid fluid is equal to the set total volume.

In the above calculation method, the same symbols involved in all formulas have the same meaning. After being marked once, they are all common for all formulas.

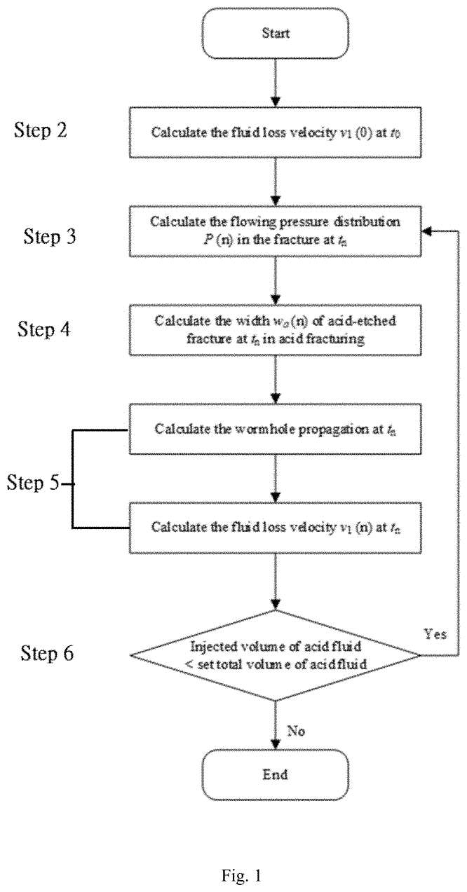

FIG. 1 shows the flow chart of calculation of dynamic fluid loss of acid-etched fracture considering wormhole propagation of the present invention.

The inventor found that the existing patent CN201810704079.4 discloses a calculation method for dynamic comprehensive fluid loss coefficient of acid fracturing in fractured reservoir. Compared with the calculation methods in the existing patent and the present invention, there are the following differences: (1) The present invention aims at the artificial fractures produced before acid fluid injection and the initial pressure in the fracture is no longer the original formation pressure, but the published patent aims at the natural fracture and the initial pressure in the fracture is the original formation pressure. (2) In the present invention, the acid fluid loss considering the wormhole effect changes dynamically as the injection process continues, while in the published patent, only Steps (3) to (6) are repeated in the calculation process, and the acid fluid loss coefficient considering the wormhole effect is a constant value. (3) The present invention aims at the pad fracturing process, specifically forming artificial fractures first and then injecting acid fluid, while the published patent relates to natural fractures, and no artificial fractures or filter cake is produced, so the calculation method of fluid loss coefficient at the initial time is different.

The present invention has the following beneficial effects:

The calculation method of the present invention takes into account the influence of the dynamic propagation of the wormholes and the continuous change of the width of acid-etched fracture on the fluid loss velocity, so as to more accurately calculate the fluid loss during acid fracturing. It is of great significance for rational design of acid fluid volume, calculation of effective acting distance of acid fluid, and prediction of the stimulation effect of acid fracturing.

The above are only the preferred embodiments of the present invention, and are not intended to limit the present invention in any form. Although the present invention has been disclosed as above with the preferred embodiments, it is not intended to limit the present invention. Those skilled in the art, within the scope of the technical solution of the present invention, can use the disclosed technical content to make a few changes or modify the equivalent embodiment with equivalent changes. Within the scope of the technical solution of the present invention, any simple modification, equivalent change and modification made to the above embodiments according to the technical essence of the present invention, are still regarded as a part of the technical solution of the present invention.

What is claimed is:

1. A calculation method for dynamic fluid loss of acid-etched fracture considering wormhole propagation, which is applied to a pad acid fracturing process, comprising the following steps:
Step 1: dividing a construction time T of injecting acid fluid into an artificial fracture into m time nodes at equal intervals, then the time step
$$Δ t = \frac{T}{m}$$
and tₙ=nΔt, where, n=0, 1, 2, 3, . . . , m, and to is an initial time for starting to inject the acid fluid;
Step 2: calculating a fluid loss velocity vₗ(0) in the artificial fracture at to;
Step 3: calculating a flowing pressure distribution P(n) in the artificial fracture at to;
Step 4: calculating a width wₐ (n) of the acid-etched fracture at t₀;
Step 5: calculating a wormhole propagation and the fluid loss velocity vₗ(n) at to; and
Step 6: substituting the fluid loss velocity vₗ(n) into Step 3, repeating Step 3 to Step 6 in turn, and calculating P(n+1), wₐ(n+1) and vₗ(n+1) until the end of acid fluid injection.

2. The calculation method for dynamic fluid loss of acid-etched fracture considering wormhole propagation according to claim 1, wherein the fluid loss velocity vₗ(0) is calculated by Formula (1) in Step 2:
$${v}_{l} ( 0 ) = \frac{2 C ( x , b )}{\sqrt{b - τ}} ; \qquad ( 1 )$$
wherein, C(x, t) is the fluid loss coefficient at x place in the fracture at t, in m/min^{0.5};
b is the construction time of artificial fracture, in min; and
τ is the time when the fluid reaches fracture x, in min.

3. The calculation method for dynamic fluid loss of acid-etched fracture considering wormhole propagation according to claim 1, wherein the flowing pressure distribution P(n) in the fracture at tₒ in Step 3 is calculated as follows:
the average velocity vₓ and v_{y} of acid fluid flowing any point (x, y) in the artificial fracture:
$$\begin{matrix}{v}_{x} = - \frac{{w}^{2}}{12 {μ}_{a}} \frac{\partial P}{\partial x} ; & ( 2 ) \\ {v}_{y} = - \frac{{w}^{2}}{12 {μ}_{a}} \frac{\partial P}{\partial y} ; & ( 3 )\end{matrix}$$
the amount of change in the acid fluid mass in the unit volume within a unit time is equal to a total inflow minus a total outflow, and then the mass conservation equation of the acid fluid in the fracture is worked out:
$$- \frac{\partial ( {v}_{x} w )}{\partial x} - \frac{\partial ( {v}_{y} w )}{\partial y} - 2 {v}_{l} = \frac{\partial w}{\partial t} ; \qquad ( 4 )$$
wherein, μₐ is the viscosity of acid fluid, in mPa·s;
P is pressure, in MPa;
vₗ is the fluid loss velocity, in m/min;
w is the fracture width, in m; w is taken as the width w_{f} of the artificial fracture at to, and taken as the width wₐ of acid-etched fracture at tₙ, and the subscript n is greater than 0.

4. The calculation method for dynamic fluid loss of acid-etched fracture considering wormhole propagation according to claim 1, wherein the width wₐ(n) of acid-etched fracture at tₙ in Step 4 is calculated as follows:
the P(n) obtained in Step 3 is taken as the internal boundary condition, and the width wₐ(n) of acid-etched fracture at tₙ is calculated by combining the initial condition formula (5) and the boundary condition formula (6);
$$\begin{matrix}\{ \begin{matrix}P ( x , y ) = 0 , ∀ x , y , t = 0 \\ {C}_{f} ( x , y ) = 0 , ∀ x , y , t = 0 \\ {w}_{a} ( x , y ) = {w}_{f} ( x , y , end ) , ∀ x , y , t = 0\end{matrix} ; & ( 5 ) \\ \{ \begin{matrix}{\int }_{- H}^{H} \frac{{w}_{a}^{3}}{12 {μ}_{a}} \frac{\partial P}{\partial x} {\vert}_{x = 0} dy = {q}_{inj} , t > 0 \\ P ( l , y ) = {P}_{e} , ∀ y , t > 0 \\ \frac{\partial P}{\partial y} {\vert}_{y = - H} = 0 , ∀ x , t > 0 \\ \frac{\partial P}{\partial y} {\vert}_{y = H} = 0 , ∀ x , t > 0 \\ {C}_{f} ( 0 , y ) = {C}_{f}^{0} , ∀ y , t > 0\end{matrix} ; & ( 6 ) \\ [ \begin{matrix}\frac{\partial ( {C}_{f} {v}_{x} {w}_{a} )}{\partial x} + \frac{\partial ( {C}_{f} {v}_{y} {w}_{a} )}{\partial y} + \\ 2 {C}_{f} {v}_{l} + 2 {k}_{g} ( {C}_{f} - {C}_{w} )\end{matrix} ] = - \frac{\partial ( {C}_{f} {w}_{a} )}{\partial t} & ( 7 ) \\ {k}_{g} ( {C}_{f} - {C}_{w} ) = R ( {C}_{w} ) & ( 8 ) \\ {\sum }_{i = 1}^{2} \frac{{β}_{i}}{{ρ}_{i} ( 1 - φ )} ( 2 η {v}_{l} {C}_{f} + 2 {R}_{i} ( {C}_{w} ) ) = \frac{\partial {w}_{a}}{\partial t} & ( 9 )\end{matrix}$$
wherein, C_{f} is the acid fluid concentration in the center of fracture, in kmol/m³;
qᵢₙⱼ is the injection rate of acid fluid, in m³/min;
Pₑ is the pressure at the fracture outlet, in MPa;
C_{f}⁰ is the acid fluid concentration at the fracture inlet, in kmol/m³;
k_{g} is the mass transfer coefficient, in m/s;
C_{w} is the acid fluid concentration at fracture wall, in kmol/m³;
R(C_{w}) is the corrosion rate of irreversible reaction in single step, in (m·kmol)/(s·m³);
βᵢ is the solubility between acid fluid and limestone or dolomite, in kg/kmol;
ρᵢ is the density of limestone or dolomite, in kg/m³;
i is the subscript, indicating different rock types;
ϕ is the porosity, dimensionless; and
η is the percentage of lost acid fluid that reacts with fracture wall rock; in most cases η≈0.

5. The calculation method for dynamic fluid loss of acid-etched fracture considering wormhole propagation according to claim 1, wherein the wormhole propagation and the fluid loss velocity vₗ(n) at tₙ in Step 5 are calculated as follows:
formulas (11) to (13) are used to simulate the dynamic propagation of the wormhole, and then Formula (10) is substituted to calculate v; the fluid loss velocity vₗ(n) is equal to the fluid loss velocity v(x, y) on the fracture surface;
$$\begin{matrix}\frac{\partial ( φ {C}_{f} )}{\partial t} + \frac{\partial }{\partial x} ( {v}_{x} {C}_{f} ) + \frac{\partial }{\partial y} ( {v}_{y} {C}_{f} ) = \frac{\partial }{\partial x} ( φ {D}_{e x} \frac{\partial {C}_{f}}{\partial x} ) + \frac{\partial }{\partial y} ( φ {D}_{e y} \frac{\partial {C}_{f}}{\partial y} ) - {\sum }_{i} {R}_{i} ( {C}_{w} ) {a}_{vi} ; & ( 10 ) \\ {R}_{i} ( {C}_{w} ) = \frac{{k}_{ci} {k}_{si} {γ}_{{H}^{+} , s}}{{k}_{ci} + {k}_{si} {γ}_{{H}^{+} , s}} {C}_{f} ; & ( 11 ) \\ \frac{\partial {V}_{i}}{\partial t} = - \frac{{M}_{a c i d} {R}_{i} ( {C}_{w} ) {a}_{vi} {α}_{i}}{{ρ}_{i}} ; & ( 12 ) \\ \frac{\partial φ}{\partial t} = - {\sum }_{i} \frac{\partial {V}_{i}}{\partial t} ; & ( 13 )\end{matrix}$$
wherein, Dₑₓ is an effective propagation coefficient tensor in x direction, in m²/s;
D_{ey} is an effective propagation coefficient tensor in y direction, in m²/s;
Rᵢ(C_{w}) is a dissolution reaction rate between acid and different minerals, in kmol/s m²;
aᵥᵢ is a surface area per unit volume of different minerals, in m²/m³;
kₛᵢ is a reaction rate constant, in m/s;
k_{ci} is mass transfer coefficient, in m/s;
γ_{H+,s} is an activity coefficient of the acid fluid, dimensionless;
Vᵢ is a volume fraction of the i^{th} mineral, dimensionless;
M_{acid} is a molar mass of the acid fluid, in kg/kmol;
α₁ is a solubility of the acid fluid, in kg/kg; and
ρi is a density of the i^{th} mineral, in kg/m³.

6. The calculation method for dynamic fluid loss of acid-etched fracture considering wormhole propagation according to claim 1, wherein Step 6 is conducted as follows:
substituting the calculated fluid loss velocity vₗ(n) into Step 3 to calculate the pressure P(n+1) in the fracture at tₙ₊₁, and then repeating Step 3 to Step 6 in turn to work out wₐ(n+1) and vₗ(n+1) until the end of acid fluid injection.

7. The calculation method for dynamic fluid loss of acid-etched fracture considering wormhole propagation according to claim 6, wherein when the injected volume of the acid fluid is equal to the set total volume of the acid fluid, the fluid injection process ends.
